(19) United States
(12) Patent Application Publication
(10) Pub. No.: US 2018/0013274 A1
(43) Pub. Date: Jan. 11, 2018

(54) RAIN-TIGHT CONNECTOR

(71) Applicant: Jinxing Yang, Roland Heights, CA (US)

(72) Inventor: Jinxing Yang, Roland Heights, CA (US)

(21) Appl. No.: 15/642,190

(22) Filed: Jul. 5, 2017

Related U.S. Application Data
(60) Provisional application No. 62/358,487, filed on Jul. 5, 2016.

(51) Int. Cl. H02G 3/06; F16L 19/08; F16L 19/065

(52) U.S. Cl. CPC H02G 3/0691; F16L 19/065; F16L 19/08

(57) ABSTRACT

A rain tight connector may include a connector body, a gland nut coupled to the connector body, and a compression ring. A locknut is coupled to the connector body on the end portion thereof opposite to the gland nut. The compression ring includes a central portion and first and second coaxial end portions. The central portion defines an annular stop. A locking unit with a plurality of locking teeth is provided in the present invention to further secure the metal tube. More specifically, the locking unit can be inserted into the compressing ring to strengthen its structure to securely hole the metal tube

### CROSS-REFERENCE TO RELATED APPLICATIONS

This application claims priority under 35 U.S.C. §119 (e) to U.S. Provisional Patent Application Ser. No. 62/358,487, filed on Jul. 5, 2016, the entire contents of which are hereby incorporated by reference.

### FIELD OF THE INVENTION

The present invention relates to rain-tight conduit fittings, and more particularly, to rain-tight conduit fittings used to terminate flexible conduit to electrical enclosures.

### BACKGROUND OF THE INVENTION

In the field of wiring homes and buildings, whether for new construction or for improvements or expansion, substantial development and product improvements have been made. Typically, these improvements are directed to enabling installers to securely mount any desired wiring in any desired location in the most efficient and quickest manner.

In any particular installation or location, various cables must be interconnected to each other as well as connected to the primary power supply in a suitable power distributing junction box or fuse box. In each of these instances, metal sheath cables, within which the electric power carrying wires are contained, must be securely mounted to the housing of the junction box or outlet box, or connected to appropriate devices, in a protected area.

Rain tight conduit fittings are commonly used to terminate an end extent of a length of flexible conduit to an electrical enclosure such as a junction box. It will be appreciated that such conduit fittings, which are often formed from a plastic material such as UV resistant PVC, may be used in both exterior and interior applications. The fittings must be able to withstand certain environmental and/or physical conditions without failure.

U.S. Pat. No. 7,841,630 to Auray et al. discloses an electrical fitting in the form of a connector or coupler for connecting an electric metal tube to an electrical box or panel or to one another. The fitting includes a body having an inlet end portion, an outlet end portion and a bore extending therethrough. A unidirectional locking device is disposed in an outermost chamber and a sealing washer disposed in an intermediate chamber. A split ring having an angularly bent leading end is provided with a series of offset circumferentially spaced unidirectional gripping tangs. The locking device may also be provided with a series of tube support tangs at the trailing end. Also, the locking device includes a tang forming an electrical bonding or ground between tubes, locking device and connector body.

However, the locking device in Auray does not seem to securely hold the metal tube. Therefore, there remains a need for a new and improved design for a rain tight connector to overcome the problems presented above.

### SUMMARY OF THE INVENTION

In one aspect, a rain tight connector intended for coupling to a rigid conduit is shown as assembled. The connector fitting includes a connector body, a gland nut threadably coupled to the connector body, and a compression ring. A locknut is threadably coupled to the connector body on the end portion thereof opposite to the gland nut. All of these elements are preferably made from moisture-resistant materials, particularly where the fitting is intended for outdoor use.

The compression ring in accordance with the preferred embodiment of the invention is continuous as opposed to split. There are accordingly no gaps therein. It is made to slip over a conduit and become a press fit member upon tightening of the connector fitting.

The compression ring includes a central portion and first and second coaxial end portions. The central portion defines an annular stop. The stop is in the form of a hollow, annular ridge of uniform diameter in the preferred embodiment. Such a stop configuration is not required for successful operation of the compression ring. The dimensions of the stop correspond to the dimensions of the gland nut and connector body, and the stop is preferably sized to function as a positive stop, preventing tightening of the gland nut beyond a certain point.

The end portions of the compression ring have substantially flat, rim-like configurations. The first end portion has dimensions that allow it to be forced between an inner surface of the gland nut and an outer surface of the conduit to which the fitting is mounted, thereby providing a rain tight seal. The second end portion is designed for insertion between an inner surface of the connector body and the outer surface of the conduit. Once so inserted, a sufficient retention force is provided to prevent the fitting from being uncoupled from the conduit. Resistance to pullout is also provided by the interaction of the first end portion of the compression ring with the gland nut 140 and conduit.

A locking unit with a plurality of locking teeth is provided in the present invention to further secure the metal tube. More specifically, the locking unit can be inserted into the compressing ring to strengthen its structure to securely hole the metal tube.

### BRIEF DESCRIPTION OF THE DRAWINGS

FIG. 1 illustrates a schematic view of the rain tight connector in the present invention.

FIG. 2 illustrates an exploded view of the rain tight connector in the present invention.

FIG. 3 illustrates a schematic view of the rain tight connector in the present invention showing the locking unit coupled with the compression ring.

FIG. 4 illustrates a schematic view of the locking unit coupled with the compression ring in the present invention.

FIG. 5 is a prior art of a rain tight connecting having a locking unit.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

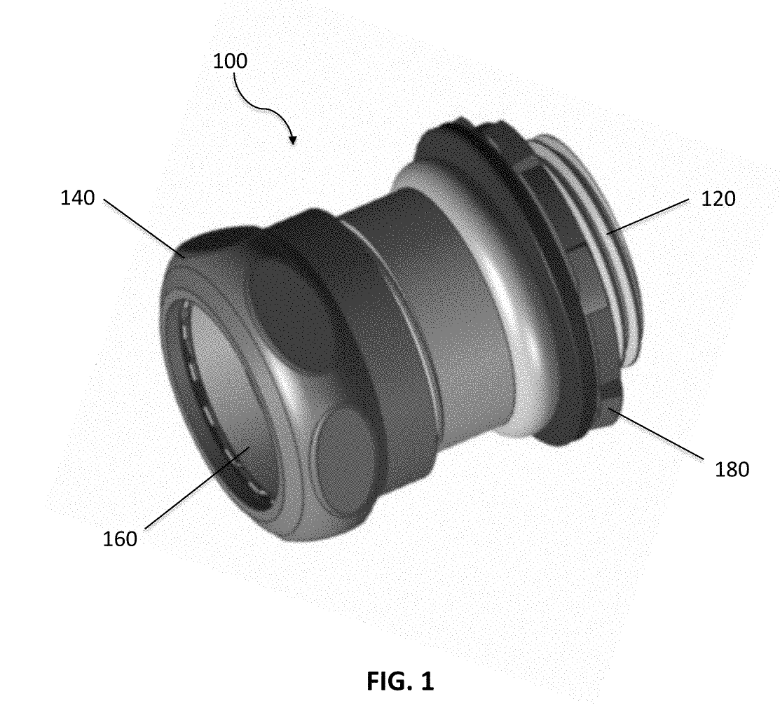

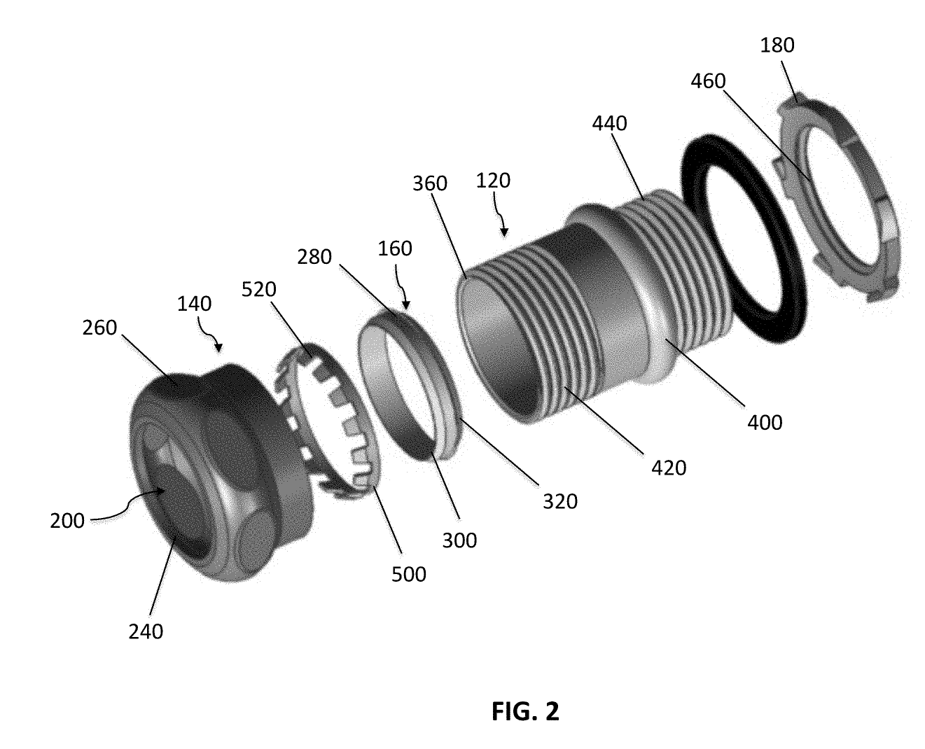

In one aspect, as shown in FIGS. 1 to 4, a connector fitting 100 intended for coupling to a rigid conduit is shown as assembled. The connector fitting includes a connector body 120, a gland nut 140 threadably coupled to the connector body 120, and a compression ring 160. A locknut 180 is threadably coupled to the connector body on the end portion thereof opposite to the gland nut 140. These elements are shown individually in FIG. 2. All of these elements are preferably made from moisture-resistant materials, particularly where the fitting is intended for outdoor use. If made from metal and used in conjunction with rigid metal conduit such as Electrical Metallic Tubing (EMT), Intermediate Metallic Conduit (IMC) or Galvanized Rigid Conduit (GRC), a fitting made in accordance with the invention will allow a rain tight seal while securing the conduit from pullout and maintaining electrical continuity. The types of materials employed in the manufacture of the connector fitting will depend on the type of conduit on which it is used and the expected environmental conditions. As used herein, the term “rigid” is not to be considered as restricted to relatively heavy conduit such as GRC, but rather as any substantially inflexible conduit. Such conduit may indeed be bendable through the use of appropriate bending equipment.

As shown in FIG. 2, the gland nut 140 includes an axial passage 200. The passage need not be entirely threaded. An annular shoulder 240 extends into the passage 200 at one of the passage's two openings. The shoulder defines a chamfer that faces inwardly. The exterior surface of the gland nut includes a plurality of diametrically opposing flat surfaces 260 to facilitate turning by a wrench.

The compression ring 160 in accordance with the preferred embodiment of the invention is continuous as opposed to split. There are accordingly no gaps therein. It is made to slip over a conduit and become a press fit member upon tightening of the connector fitting 100. The ring can be made in any of a variety of diameters in order to fit different size conduits and is otherwise dimensioned to interact with the gland nut and connector body with which it is used. It is made from a material that would be compatible with the conduit material as well as the material(s) used in the manufacture of the other elements of the connector fitting. Zinc-plated steel may be used to manufacture the compression ring as well as the gland nut, connector body and locknut. Such material is suitable for use for fittings employed with Electrical Metallic Tubing (EMT) as well as metal conduit having different wall thickness ranges such as IMC and GRC.

The compression ring 160 includes a central portion 280 and first and second coaxial end portions 300, 320. The central portion defines an annular stop. The stop is in the form of a hollow, annular ridge of uniform diameter in the preferred embodiment. Such a stop configuration is not required for successful operation of the compression ring. The dimensions of the stop correspond to the dimensions of the gland nut and connector body. As discussed hereafter, the stop is preferably sized to function as a positive stop, preventing tightening of the gland nut beyond a certain point. The point preferably corresponds to where the amount of torque specified for the fitting has been applied by the user. It also preferably corresponds to the point where the gland nut 140 bottoms out against the connector body, as discussed below. The end portions 300, 320 of the compression ring have substantially flat, rim-like configurations. The first end portion 300 has dimensions that allow it to be forced between an inner surface of the gland nut and an outer surface of the conduit to which the fitting is mounted, thereby providing a rain tight seal. The second end portion 320 is designed for insertion between an inner surface of the connector body 120 and the outer surface of the conduit. Once so inserted, a sufficient retention force is provided to prevent the fitting 100 from being uncoupled from the conduit. Resistance to pullout is also provided by the interaction of the first end portion of the compression ring 160 with the gland nut 140 and conduit.

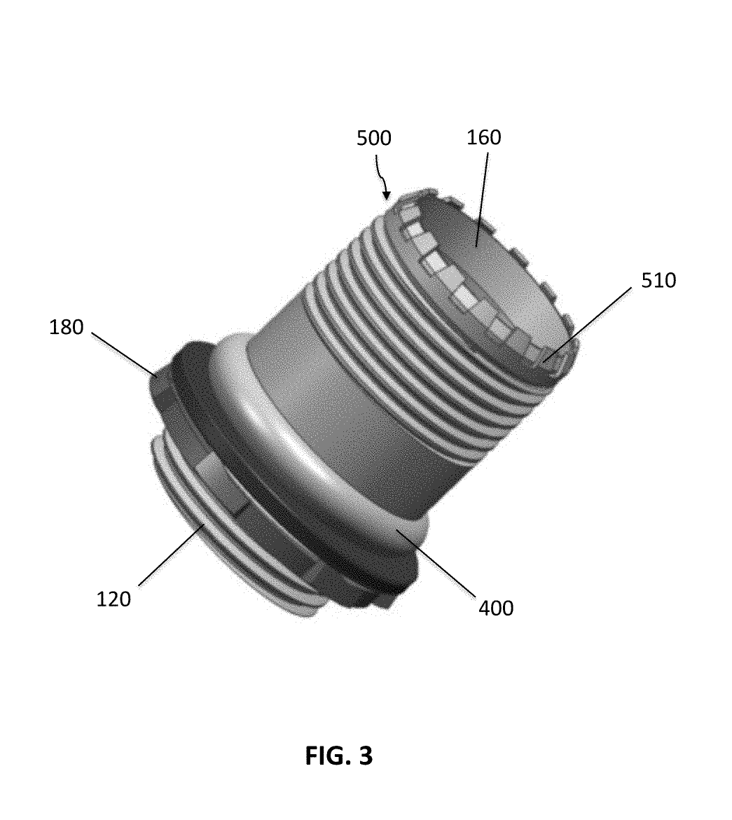

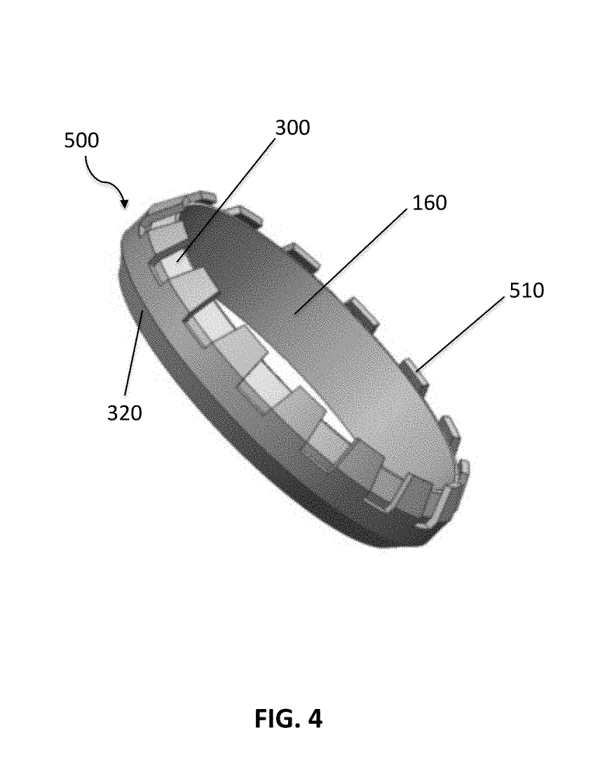

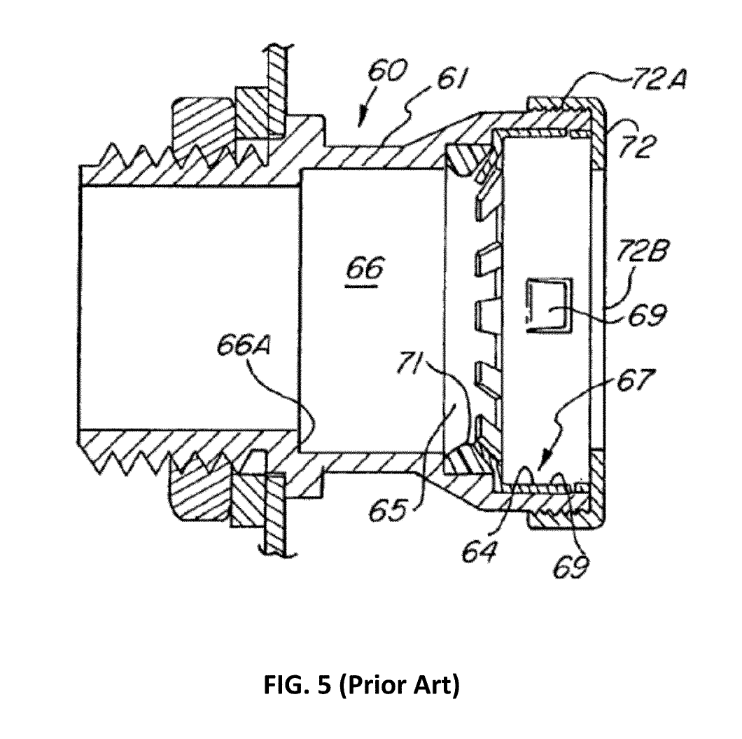

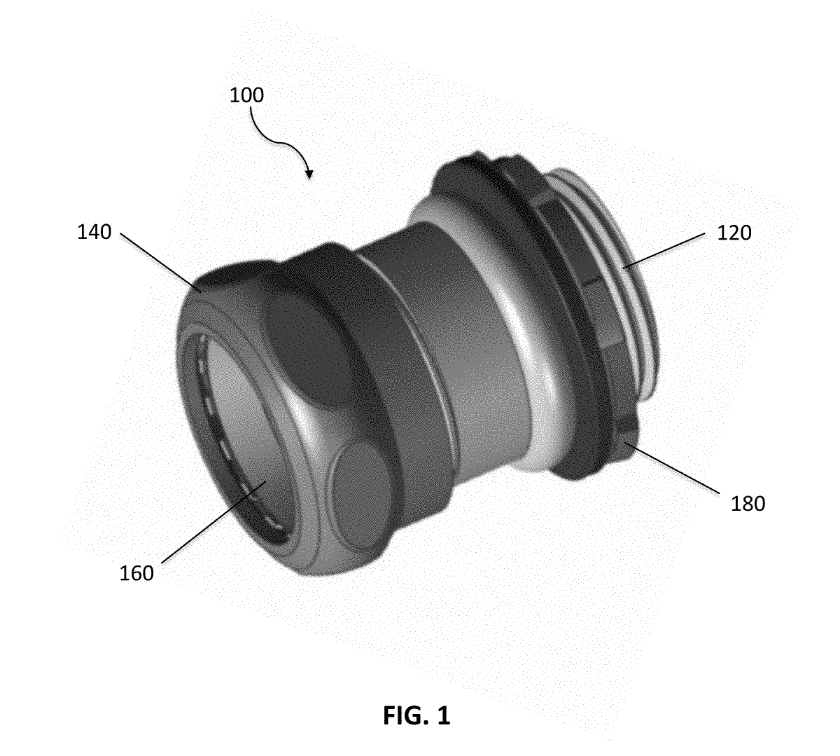

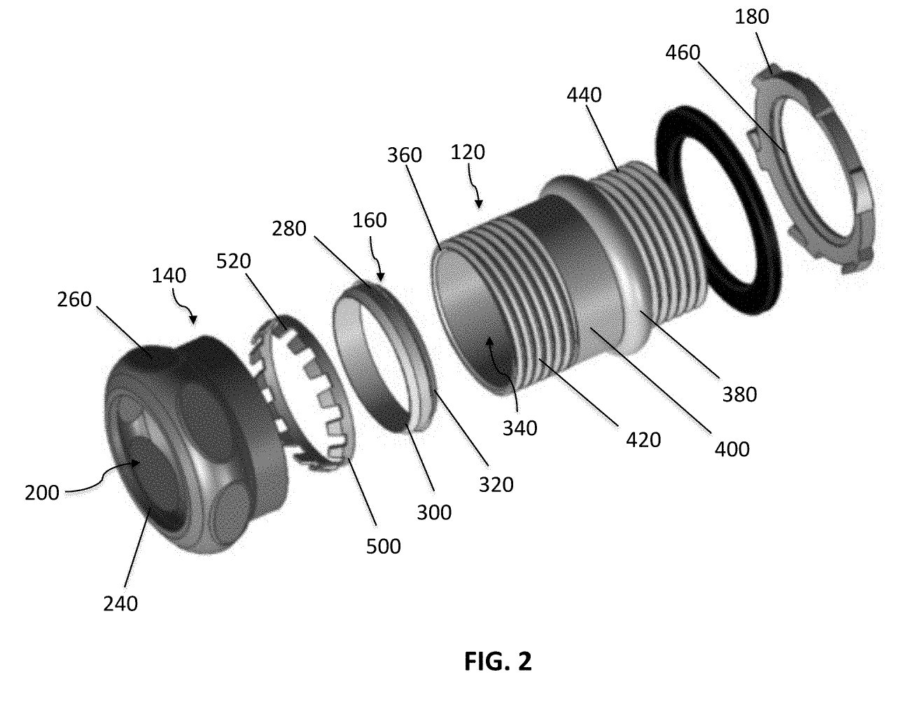

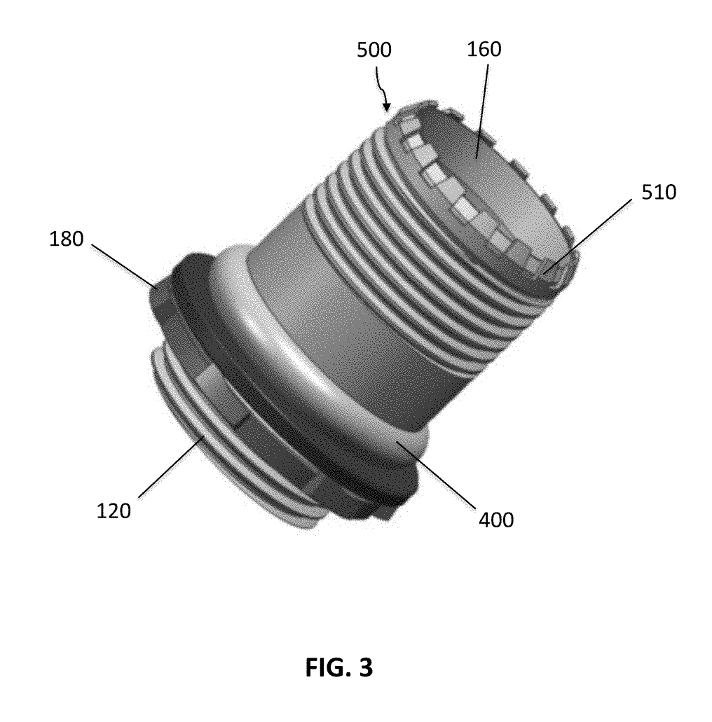

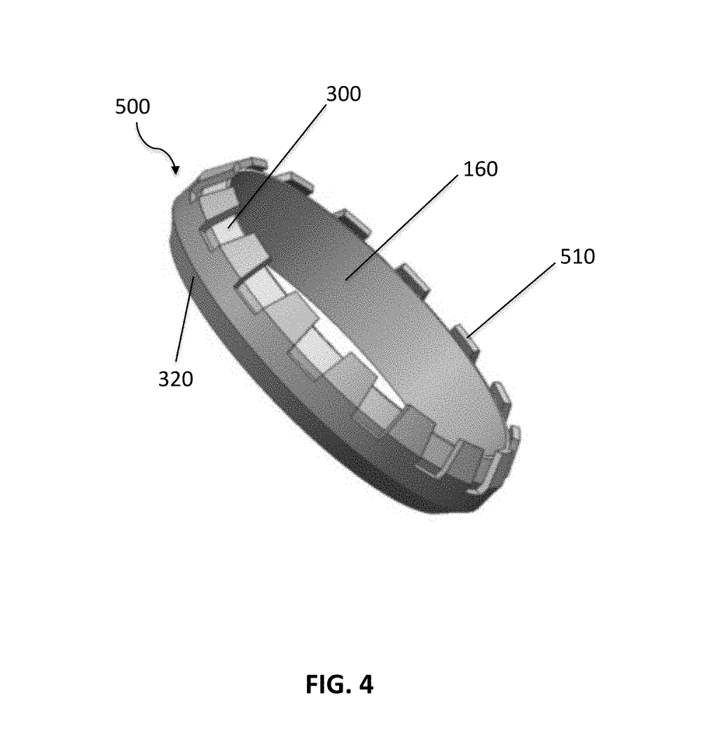

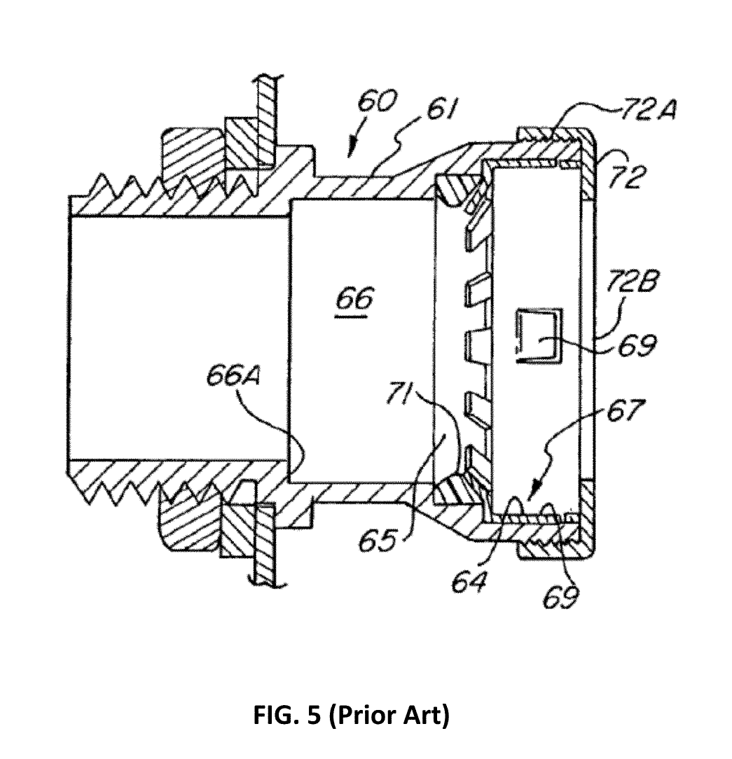

A locking unit 500 with a plurality of locking teeth 520 is provided in the present invention to further secure the metal tube. More specifically, the locking unit can be inserted into the compressing ring 160 to strengthen its structure to securely hole the metal tube as shown in FIGS. 3 and 4.

While the preferred compression ring is symmetrical to allow installation in either direction, such symmetry is not required. Non-symmetrical geometries may be employed if required to properly interact with the internal structures of the gland nut and connector body.

The connector body 120 includes a cylindrical passage 340 for receiving a conduit. The end of the connector body intended to be received in the gland nut 140 includes a chamfer 360 adjoining an opening to the passage 340. An enlarged portion 380 of the connector body includes flats 400 for facilitating application of a wrench. Two threaded sections 420, 440 extend from the enlarged portion. One of the sections is designed for threaded coupling to the gland nut. The other threaded section 440 receives the threaded opening 460 in the locknut.

The connector fitting 100 is intended to be provided to the user in the assembled form shown in FIG. 1. It can alternatively be provided as individual components, leaving assembly to the user. Starting with the fitting 100 as assembled, the user slides the fitting over a rigid conduit with the gland nut as the leading end. The end of the conduit abuts against an internal shoulder 480 in the connector body 120 when the fitting is properly mounted. The user then rotates the gland nut 140 with respect to the connector body 120, causing it to travel towards the enlarged portion 380 of the connector body. As the gland nut is tightened, the second end portion 320 of the compression ring is urged between the connector body and conduit. The chamfer 360 at the end of the connector body facilitates this process, guiding this end portion between these elements. As rotation of the gland nut continues, the stop 280 extending from the compression ring 160 adjoins the chamfered end of the connector body and prevents further movement of the compression ring in this direction. Subsequent gland nut rotation causes the first end portion 300 of the compression ring to be forced between the shoulder 240 and the conduit such that the first end portion is press fit therebetween, providing a rain tight seal. In the preferred embodiment of the invention, the first end portion of the compression ring has sufficient length that it emerges partially beyond the gland nut and becomes visible to the installer.

The elements of the connector fitting 100 are designed to provide two different visual indicators that the gland nut has been properly torqued as well as a tactile indicator. They are also designed so that the fitting is securely retained on the conduit and a rain tight seal is provided. The ability to indicate proper torqueing is desirable in that the installer may not have the tools required to know when the gland nut has been torqued in accordance with applicable code requirements. The connector fitting 100 is designed to ensure such requirements can be met should the user fail to employ a torque wrench in installing the fitting. It will be appreciated that fewer torque indicators than the three provided in the preferred connector fitting can be successfully employed.

In summary, a connector fitting is provided with a continuous compression ring that provides superior performance in forming a rain tight seal than split rings. The gland nut preferably bottoms out against the connector body to provide a visual indicator as to when sufficient torque has been applied. A portion of the compression ring becomes visible upon achieving proper torque, providing a second visual indicator that proper torque has been achieved. A portion of the conduit may be deformed near the gland nut opening to provide a rain tight seal. The continuous compression ring is preferably provided with two substantially flat coaxial end portions on opposite sides of a raised area or stop. The compression ring is designed to provide a positive stop when proper torque is achieved.

The flat surfaces of the compression ring are believed to conform to irregularities that may be present in the surface of the conduit, thereby providing a good seal when compressed by the gland nut. Compression rings that are simply arched or curved and have no such flat sections would not be likely to conform as well to such conduit surface irregularities.

The compression ring 160 is designed so that the raised stop 280 cooperates with the gland nut such that when proper torque is achieved, the gland nut is no longer able to compress the compression ring. The stop further promotes even distribution of ring movement as the gland nut is tightened. The stop 280 prevents additional rotation of the gland nut about the connector body threads when proper torque is achieved. Accordingly, the compression ring can only be compressed a certain amount, i.e., that corresponding to the proper torque. This is preferably achieved at the same time the gland nut bottoms out against the connector body. It will be appreciated, however, that even if the gland nut did not bottom out at this point, the gland nut would still be prevented from further turning by the above-described action of the compression ring 140 and the stop 280 thereof. By employing conductive metal elements in the manufacture of the connector fitting 100, electrical continuity is provided when it is secured to EMT or other metal conduit. It is important to note that the locking unit 500 with a plurality of locking teeth 520 is provided in the present invention to further secure the metal tube. More specifically, the locking unit 500 can be inserted into the compressing ring 160 to strengthen its structure to securely hole the metal tube.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A connector fitting includes a connector body, a gland nut coupled to the connector body, and a compression ring, wherein the gland nut includes an axial passage, and an annular shoulder extending into the passage at one of the passage's two openings; the compression ring includes a central portion defining an annular stop, a first coaxial end portion and a second coaxial end portion, wherein the first end portion is configured to be forced between an inner surface of the gland nut and an outer surface of a conduit to which the fitting is mounted, thereby providing a rain tight seal, and the second end portion is configured for insertion between an inner surface of the connector body and the outer surface of the conduit to provide a sufficient retention force to prevent the connector fitting from being uncoupled from the conduit.

2. The connector fitting of claim 1, further comprising a locknut coupled to the connector body on the end portion thereof opposite to the gland nut.

3. The connector fitting of claim 1, wherein an exterior surface of the gland nut includes a plurality of flat surfaces to facilitate turning by a wrench.

4. The connector fitting of claim 1, further comprising a locking unit with a plurality of locking teeth, and the locking unit is configured receive the compressing ring to strengthen the structure thereof.

5. The connector fitting of claim 1, wherein the connector body includes a cylindrical passage for receiving the conduit, and one end of the connector body is configured to be received in the gland nut with a chamfer 360 adjoining an opening to the passage.

6. The connector fitting of claim 1, wherein both the first and second coaxial end portions of the compression ring have substantially flat, rim-like configurations.
